(19) United States
(12) Patent Application Publication
(10) Pub. No.: US 2020/0072212 A1
(43) Pub. Date: Mar. 5, 2020

(54) COMPRESSOR AND REFRIGERATION CYCLE DEVICE

(71) Applicants: Mitsubishi Electric Corporation, Tokyo (JP); Ubukata Industries Co., Ltd., Nagoya-shi, Aichi (JP)

(72) Inventors: Kanichiro SUGIURA, Tokyo (JP); Shinichi TAKAHASHI, Tokyo (JP); Hiroshi MURATA, Nagoya-shi, Aichi (JP); Hideki OKUMURA, Nagoya-shi, Aichi (JP); Takehiko OKUMURA, Nagoya-shi, Aichi (US)

(21) Appl. No.: 16/468,166

(22) PCT Filed: Feb. 14, 2017
(86) PCT No.: PCT/JP2017/005316

§ 371 Date: Jun. 10, 2019

(51) Int. Cl. F04B 49/02; F04B 49/10; H02P 27/06

(52) U.S. Cl. CPC F04B 49/022; H02P 27/06; F04B 49/10

(57) ABSTRACT

A compressor includes a sealed container, a compression element installed inside the sealed container and configured to compress refrigerant, a motor element installed inside the sealed container as a drive source of the compression element, and a pressure switch installed inside the sealed container and configured to open a normally closed contact when pressure inside the sealed container reaches or exceeds a first set pressure, where the pressure switch is connected to all of connection parts of windings forming a part of the motor element.

### TECHNICAL FIELD

The present invention relates to a compressor including a sealed container, and a refrigeration cycle device provided with the compressor.

### BACKGROUND ART

Various means for protecting element units forming a refrigeration cycle device from an abnormal pressure rise in a refrigerant circuit have hitherto been conceived. For example, some refrigerant circuits are provided with a pressure switch. When a pressure switch is provided, the pressure switch is activated in response to an abnormal pressure rise in the refrigerant circuit to stop forcefully driving of a compressor, and each element component can thereby be protected. For example, the pressure switch is installed outside the compressor and at a high-pressure part of the refrigerant circuit. As targets of protection, an element unit such as a compressor, an evaporator, a condenser or an expander, and a refrigerant pipe connecting each element unit may be cited, for example.

Furthermore, indirect protection from an abnormal pressure rise can be achieved by detecting a current of a compressor, a temperature of refrigerant gas discharged from the compressor, or a temperature of a sealed container forming the compressor.

However, a pressure switch installed outside a compressor is not always able to cope with an abnormal pressure rise. For example, in the case where a pipe is clogged because of defective welding or the like at a discharge portion of the compressor, there is no occurrence of abnormal pressure rise outside the compressor, and a pressure switch installed outside the compressor is not able to cope with such a situation. In such a case, the compressor continues to operate, and a pressure inside a sealed container is abnormally increased. When a pressure inside the sealed container is abnormally increased, this possibly leads to damage to a component forming a compression element of the compressor or damage to the sealed container.

To cope with such a problem, it is proposed to provide the pressure switch inside the compressor (see Patent Literature 1, for example).

Patent Literature 1 describes a sealed compressor that is “a sealed compressor of a high pressure type in a sealed case, where a motor unit and a compression mechanism unit driven by the motor unit are housed in the sealed case, and refrigerant that is compressed by the compression mechanism unit is discharged into a space inside the sealed case, wherein a pressure switch for operating and stopping the sealed compressor when a pressure inside the sealed case reaches or exceeds a predetermined value is provided inside the sealed case, and the pressure switch is set to operate at a pressure that is higher by 0.1 MPa to 1.5 MPa than a condensing pressure when a condensing temperature of refrigerant that is used is 65 degrees C., and is not recovered after operating once”.

### CITATION LIST

### Patent Literature

Patent Literature 1: Japanese Patent No. 5005449

### SUMMARY OF INVENTION

### Technical Problem

With the compressor described in Patent Literature 1, one pressure switch disconnects one phase of a motor element, and thus, when the compressor is driven in three phases, remaining two phases remain in an energized state. Therefore, with Patent Literature 1, there is a possibility of an abnormal pressure rise due to operation in the two phases which are in the energized state. Accordingly, the energized state of the two states has to be detected by a controller provided in a refrigeration cycle device to protect the compressor.

It is conceivable to provide two or more pressure switches to disconnect all of the three phases. However, in such a case, timings of disconnection are possibly deviated from one another depending on individual differences among the pressure switches. Furthermore, providing a plurality of pressure switches gives rise to a problem of increased cost, and moreover, there is also a problem that an installation space is difficult to secure inside the sealed container.

Furthermore, with the compressor described in Patent Literature 1, a condensing pressure when a condensing temperature of refrigerant that is used is 65 degrees C. is used as a reference relative to an operating pressure of the pressure switch. Accordingly, in Patent Literature 1, protection from an abnormal pressure rise of refrigerant that is placed in a supercritical state at 65 degrees C., such as carbon dioxide, is not achieved.

Furthermore, with the compressor described in Patent Literature 1, recovery is not performed once operation is performed. Accordingly, in a case where a refrigerant circuit of the refrigeration cycle device reaches a high pressure because of an erroneous valve operation, and the pressure switch is operated, operation of the compressor is disabled. Tasks which cause an erroneous valve operation may be installation of the refrigeration cycle device, transfer of the refrigeration cycle device, and replacement of the compressor, for example. Moreover, whether the pressure switch operates normally or not cannot be checked at the time of manufacture of the refrigeration cycle device.

The present invention has been made to solve such problems, and an object thereof is to provide a compressor provided with a pressure switch that is capable of coping with an abnormal pressure rise in a sealed container by a simple configuration, and a refrigeration cycle device provided with the compressor.

### Solution to Problem

A compressor of one embodiment according to the present invention includes a sealed container; a compression element installed inside the sealed container and configured to compress refrigerant; a motor element installed inside the sealed container as a drive source of the compression element; and a pressure switch installed inside the sealed container and configured to open a normally closed contact when pressure inside the sealed container reaches or exceeds a first set pressure, wherein the pressure switch is connected to all of connection parts of windings forming a part of the motor element.

A refrigeration cycle device of another embodiment according to the present invention includes a refrigerant circuit where the compressor described above, a condenser, an expansion device, and an evaporator are connected by a high-pressure side pipe and a low-pressure side pipe.

### Advantageous Effects of Invention

According to the compressor of one embodiment according the present invention, there is provided the pressure switch that opens the normally closed contact when the pressure inside the sealed container reaches or exceeds the first set pressure, and thus, the motor element can be reliably stopped in response to an abnormal pressure rise inside the sealed container.

According to the refrigeration cycle device of another embodiment according to the present invention, there is provided the compressor described above, and thus, the compressor can be surely protected from an abnormal pressure rise in the sealed container of the compressor, and reliability can be enhanced.

### BRIEF DESCRIPTION OF DRAWINGS

FIG. 1 is a schematic configuration diagram schematically illustrating a configuration of a compressor according to Embodiment 1 of the present invention.

FIG. 2 is a schematic configuration diagram illustrating an example electrical configuration of the compressor according to Embodiment 1 of the present invention.

FIG. 3 is a graph describing an example operation of a pressure switch installed in the compressor according to Embodiment 1 of the present invention.

FIG. 4 is a schematic configuration diagram illustrating another example electrical configuration of the compressor according to Embodiment 1 of the present invention.

FIG. 5 is a schematic configuration diagram illustrating an example electrical configuration of a compressor according to Embodiment 2 of the present invention.

FIG. 6 is a schematic configuration diagram illustrating another example electrical configuration of the compressor according to Embodiment 2 of the present invention.

FIG. 7 is a refrigerant circuit diagram schematically illustrating a refrigerant circuit configuration of a refrigeration cycle device according to Embodiment 3 of the present invention.

### DESCRIPTION OF EMBODIMENTS

Hereinafter, compressors and a refrigeration cycle device according to the present invention will be described with reference to the drawings.

Configurations, operations and the like described below are merely examples, and the compressors and the refrigeration cycle device according to the present invention are not limited to such configurations, operations and the like. In each drawing, same or similar parts are denoted by the same reference sign, or a reference sign for the same or similar parts may be omitted. Furthermore, illustration of details is simplified or omitted as appropriate. Moreover, a redundant or similar description is simplified or omitted as appropriate.

### Embodiment 1

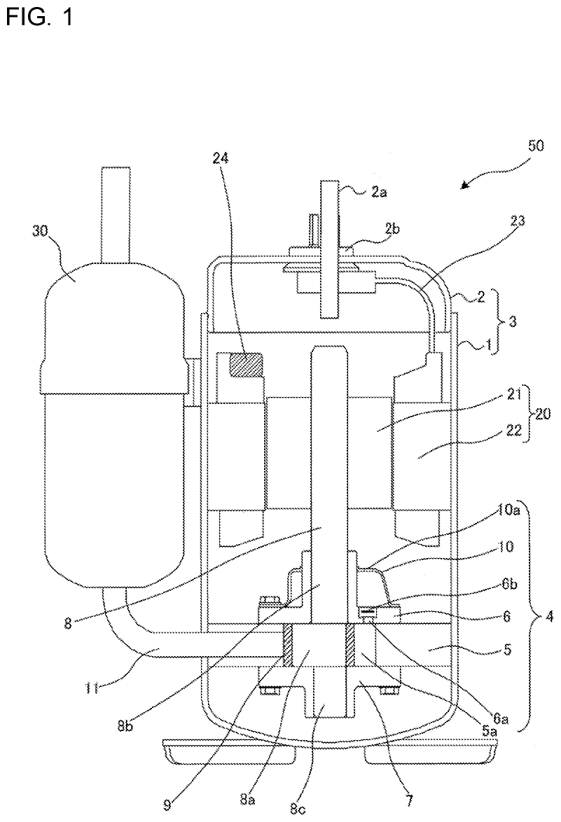

FIG. 1 is a schematic configuration diagram schematically illustrating a configuration of a compressor 50 according to Embodiment 1 of the present invention. The compressor 50 will be described with reference to FIG. 1. The compressor 50 is a structural element of a refrigerant circuit of a refrigeration cycle device for a refrigerator, a freezer, an automatic vending machine, an air-conditioning device, a freezing device, or a water heater, for example. Meanwhile, FIG. 1 illustrates a rotary compressor as an example of the compressor 50.

### [Configuration of Compressor 50]

The compressor 50 compresses and discharges, refrigerant that is suctioned. The compressor 50 is a sealed compressor provided with a sealed container 3. The sealed container 3 is formed of a lower container 1 and an upper container 2. A compression element 4 and a motor element 20 are housed in the sealed container 3. For example, FIG. 1 illustrates an example where the compression element 4 is housed on a lower side in the sealed container 3, and the motor element 20 is housed on an upper side in the sealed container 3. A bottom portion of the sealed container 3 functions as an oil reservoir where refrigerating machine oil is stored. The refrigerating machine oil mainly lubricates a sliding portion of the compression element 4.

A suction pipe 11 communicating with an accumulator 30 is connected to the lower container 1 of the sealed container 3. The compressor 50 takes refrigerant (gas refrigerant) into the sealed container 3 from the accumulator 30 through the suction pipe 11. Moreover, a discharge pipe 2a is connected to an upper part of the upper container 2 of the sealed container 3. The compressor 50 discharges refrigerant that is compressed by the compression element 4 to outside through the discharge pipe 2a. A description of the accumulator 30 will be given later.

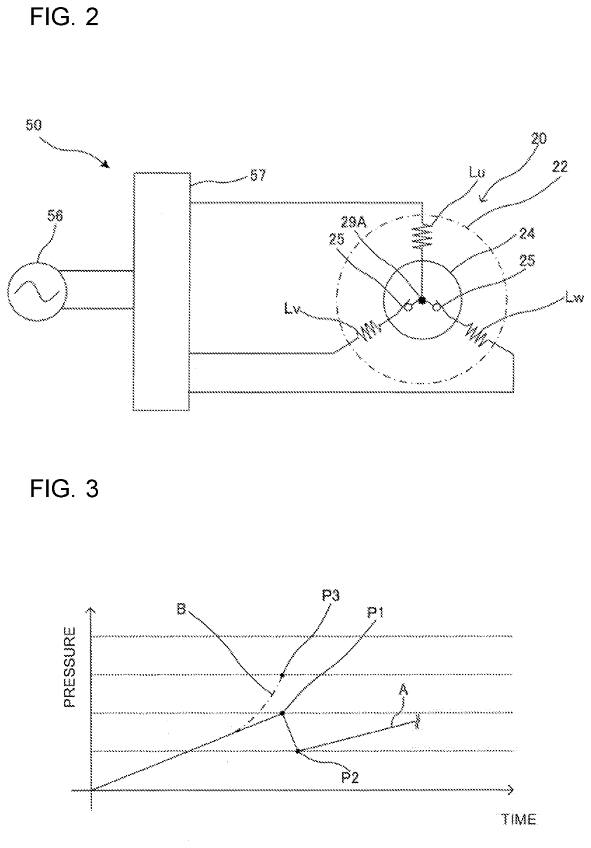

A pressure switch 24 is provided inside the sealed container 3 of the compressor 50. FIG. 1 illustrates, as an example, a state where the pressure switch 24 is installed above a stator 22. Details of the pressure switch 24 will be given later with reference to FIG. 2 and subsequent drawings.

### <Compression Element 4>

The compression element 4 has a function of compressing refrigerant by being driven by the motor element 20.

The compression element 4 is configured by including a cylinder 5, a rolling piston 9, an upper bearing 6, a lower bearing 7, a drive shaft 8, a discharge muffler 10, a vane (not illustrated), and the like.

An outer periphery of the cylinder 5 is substantially circular in a plan view, and the cylinder 5 includes, in its inside, a cylinder chamber 5a that is a space having a substantially circular shape in a plan view. In a side view, the cylinder 5 has a predetermined height, that is, a thickness, in an axial direction. The cylinder chamber 5a is open at both ends in the axial direction. The cylinder chamber 5a functions as a compression chamber. A vane slot (not illustrated) communicating with the cylinder chamber 5a and extending in a radial direction is provided in the cylinder 5 so as to penetrate in the axial direction. A back pressure chamber (not illustrated) is formed on a back (outside) of the vane slot. The back pressure chamber is a space that is substantially circular in a plan view and communicates with the vane slot.

The cylinder 5 is also provided with a suction port (not illustrated) where gas refrigerant suctioned through the suction pipe 11 flows through. The suction port is formed in a manner penetrating to the cylinder chamber 5a from an outer peripheral surface of the cylinder 5.

The cylinder 5 is also provided with a discharge port (not illustrated) configured to discharge refrigerant that is compressed in the cylinder chamber 5a from the cylinder chamber 5a. The discharge port is formed by cutting away a part of an edge portion of an upper end surface of the cylinder 5.

The rolling piston 9 is formed into a ring shape, and is housed in the cylinder chamber 5a in a manner capable of eccentric rotation. Furthermore, an inner peripheral portion of the rolling piston 9 is fitted to an eccentric shaft portion 8a of the drive shaft 8 such that it can slide.

The vane is housed in the vane slot. The vane that is housed in the vane slot is constantly pressed against the rolling piston 9 by a vane spring (not illustrated) provided in the back pressure chamber. When a pressure inside the sealed container 3 is high, and operation is started, a force due to a pressure difference between the high pressure inside the sealed container 3 and a pressure in the cylinder chamber 5a acts on the compressor 50, on the back of the vane (i.e. on the back pressure chamber side). Therefore, the vane spring is mainly used for a purpose of pressing the vane against the rolling piston 9 at a time of activation of the compressor 50 when there is no pressure difference between the inside of the sealed container 3 and the inside of the cylinder chamber 5a.

Meanwhile, the vane has a flat, substantially cuboid shape. Specifically, the vane has a flat, substantially cuboid shape with a length (thickness) in a circumferential direction smaller than lengths in a radial direction and an axial direction.

The upper bearing 6 has an inverted T shape in a side view. The upper bearing 6 fits to a main shaft portion 8b, which is a part of the drive shaft 8, higher than the eccentric shaft portion 8a such that it can slide. The upper bearing 6 blocks one end surface (end surface on the motor element 20 side) of the cylinder chamber 5a, including the vane slot of the cylinder 5. A discharge hole 6a is formed in the upper bearing 6. The discharge hole 6a is formed at a substantially same position, in a plan view, as the discharge port formed in the cylinder 5. A discharge valve 6b is attached to the discharge hole 6a.

The discharge valve 6b opens or closes the discharge hole 6a by receiving the pressure inside the cylinder chamber 5a and the pressure inside the sealed container 3. When the pressure inside the cylinder chamber 5a is lower than the pressure inside the sealed container 3, the discharge valve 6b is pressed against the discharge port to block the discharge hole 6a. On the other hand, when the pressure inside the cylinder chamber 5a is higher than the pressure inside the sealed container 3, the discharge valve 6b is pushed upward by the pressure inside the cylinder chamber 5a to thereby open the discharge hole 6a. When the discharge hole 6a is opened, refrigerant that is compressed inside the cylinder chamber 5a is led outside the cylinder chamber 5a.

The lower bearing 7 has a T shape in a side view. The lower bearing 7 fits to a sub shaft portion 8c which is a part of the drive shaft 8 lower than the eccentric shaft portion 8a such that it can slide. The lower bearing 7 blocks the other end surface (side surface on the oil reservoir side) of the cylinder chamber 5a, including the vane slot of the cylinder 5.

The discharge muffler 10 is attached to an upper side (the motor element 20 side) of the upper bearing 6. High-temperature, high-pressure gas refrigerant that is discharged from the discharge hole 6a formed in the upper bearing 6 enters the discharge muffler 10 once, and is then ejected into the sealed container 3 from a discharge hole 10a formed in the discharge muffler 10. Meanwhile, the discharge valve 6b and the discharge muffler 10 may be provided to the lower bearing 7, or to both the upper bearing 6 and the lower bearing 7.

The accumulator 30 is provided beside the sealed container 3. The accumulator 30 suctions low-pressure gas refrigerant from a refrigeration cycle. The accumulator 30 prevents liquid refrigerant to be suctioned directly into the cylinder chamber 5a of the cylinder 5 when the liquid refrigerant returns from the refrigeration cycle. The accumulator 30 is connected to the suction port of the cylinder 5 by the suction pipe 11. The accumulator 30 is fixed to a side surface of the sealed container 3 by welding, for example.

The high-temperature, high-pressure gas refrigerant compressed by the compression element 4 flows through the motor element 20 from the discharge hole 10a of the discharge muffler 10, and is discharged outside the compressor 50 from the discharge pipe 2a.

### <Motor Element 20>

The motor element 20 has a function of driving the compression element 4.

The motor element 20 includes a rotor 21, the stator 22, and the like. The stator 22 is fixed while being in contact with an inner peripheral surface of the sealed container 3. The rotor 21 is installed inside the stator 22 with a gap being formed between the rotor and the stator.

The stator 22 at least includes a stator core, which is a plurality of electromagnetic steel sheets that are laminated one on another, and windings that are concentratedly wound around teeth of the stator core across insulating elements. A lead wire 23 is connected to the windings of the stator 22. The lead wire 23 is connected to a glass terminal 2b that is provided at the upper container 2 to supply power from outside the sealed container 3.

The rotor 21 at least includes a rotor core, which is a plurality of electromagnetic steel sheets that are laminated one on another, and a permanent magnet inserted into the rotor core. The main shaft portion 8b of the drive shaft 8 is shrink-fitted or press-fitted at a center of the rotor core.

### [Operation of Compressor 50]

Power is supplied to the stator 22 of the motor element 20 through the lead wire 23. A current thereby flows through the windings of the stator 22, and a magnetic flux is generated from the windings. The rotor 21 of the motor element 20 rotates by an action of the magnetic flux generated from the windings and a magnetic flux generated from the permanent magnet of the rotor 21. The drive shaft 8 fixed to the rotor 21 is rotated by the rotation of the rotor 21. The rolling piston 9 of the compression element 4 eccentrically rotates inside the cylinder chamber 5a of the cylinder 5 by the rotation of the drive shaft 8.

A space, inside the cylinder chamber 5a, between the cylinder 5 and the rolling piston 9 is partitioned into two by the vane, not illustrated. Capacities of the two spaces change with the rotation of the drive shaft 8. In one space, low-pressure gas refrigerant is suctioned from the accumulator 30 by the capacity being gradually increased. In the other space, gas refrigerant inside is compressed by the capacity being gradually reduced.

The gas refrigerant that is compressed to reach a high pressure and a high temperature pushes the discharge valve 6b upward, and is discharged into a space inside the sealed container 3 through the discharge hole 6a and the discharge hole 10a of the discharge muffler 10. The gas refrigerant that is discharged flows through a gap of the motor element 20, and is discharged outside the sealed container 3 from the discharge pipe 2a joined to a top part of the sealed container 3. The refrigerant that is discharged outside the sealed container 3 circulates through the refrigeration cycle and then returns to the accumulator 30.

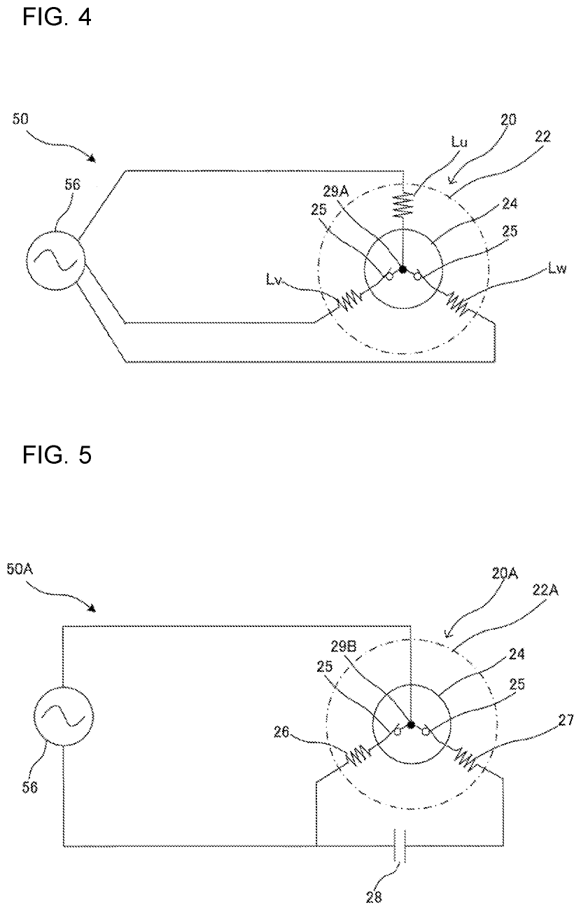

FIG. 2 is a schematic configuration diagram illustrating an example electrical configuration of the compressor 50. FIG. 3 is a graph describing an example operation of the pressure switch 24 installed in the compressor 50. FIG. 4 is a schematic configuration diagram illustrating another example of electrical configuration of the compressor 50. Electrical configurations of the compressor 50 and an operation of the pressure switch 24 will be described with reference to FIGS. 2 to 4. Meanwhile, in FIG. 3, a horizontal axis indicates time, and a vertical axis indicates pressure.

As described above, the stator 22 includes windings. As illustrated in FIG. 2, three phases of windings Lu, Lv, and Lw are connected by star connection, with each having one end connected to a neutral point 29A, which is a connection part of the windings. The pressure switch 24 including two or more normally closed contacts 25 is connected to the neutral point 29A. The pressure switch 24 is configured such that the normally closed contacts 25 are opened when the pressure inside the sealed container 3 reaches or exceeds a predetermined operating pressure.

Power for driving the compressor 50 is supplied to the stator 22 by a drive control device 57 through the glass terminal 2b and the lead wire 23, the drive control device 57 configured to convert an AC voltage of a commercial AC power supply 56 into a DC and to convert the DC into an AC voltage by switching and applying the AC voltage to each winding.

The compressor 50 compresses refrigerant in the cylinder chamber 5a, which functions as the compression chamber by introducing the refrigerant in the accumulator 30 into the cylinder chamber 5a through the suction pipe 11 and the suction port, and by causing the rolling piston 9 of the motor element 20 to eccentrically rotate by the power supplied from the glass terminal 2b. The compressed refrigerant is discharged into the sealed container 3 through the discharge hole 6a and the discharge hole 10a, flows through the gap of the motor element 20, and is then discharged outside the compressor 50 from the discharge pipe 2a.

When the compressor 50 is operated, and the pressure inside the sealed container 3 reaches or exceeds a predetermined pressure that is set in advance (a first set pressure P1 illustrated in FIG. 3), the pressure switch 24 operates, and opens the normally closed contacts 25. When the normally closed contacts 25 are opened, the winding Lu, the winding Lv, and the winding Lw are disconnected from one another, and a current does not flow to the stator 22. When a current does not flow to the stator 22, the operation of the compressor 50 is stopped, and a pressure rise in the sealed container 3 is suppressed.

On the other hand, when the pressure inside the sealed container 3 falls to or below a predetermined pressure that is set in advance (a second set pressure P2 illustrated in FIG. 3), the pressure switch 24 is recovered, and the normally closed contacts 25 are closed. When the normally closed contacts 25 are closed, a current flows between the winding Lu, the winding Lv, and the winding Lw. When a current flows to the stator 22, the motor element 20 starts to operate again, and operation of the compressor 50 is started again.

When the compressor 50 is operated, and the pressure inside the sealed container 3 exceeds a predetermined pressure that is set in advance (a third set pressure P3 illustrated in FIG. 3), the pressure switch 24 operates, and causes the normally closed contacts 25 to be normally open. In this case, the pressure switch 24 keeps the normally closed contacts 25 open, maintains a state where the winding Lu, the winding Lv, and the winding Lw are disconnected from each other, and is not able to be recovered. Accordingly, in a state where the pressure inside the sealed container 3 is higher than the predetermined pressure (the third set pressure P3 illustrated in FIG. 3), the normally closed contacts 25 remain open and a current does not flow to the stator 22, and a state is maintained in which operation of the compressor 50 is stopped. In such a case, it is highly possible that there is some type of abnormality occurring in the compressor 50, and the pressure switch 24 stops the compressor 50 so as to not able to be recovered.

Meanwhile, also in a case where the pressure inside the sealed container 3 exceeds the third set pressure P3 after reaching the first set pressure P1 and the normally closed contacts 25 are opened by the pressure switch 24, recovery of the pressure switch 24 is disabled.

As described above, the compressor 50 includes the pressure switch 24 inside the sealed container 3, the pressure switch 24 configured to operate and stop the compressor 50 when the pressure inside the sealed container 3 reaches a predetermined pressure. Accordingly, with the compressor 50, protection from an abnormal pressure rise due to clogging of the discharge pipe or the like, which is not achieved when the pressure switch is provided outside the compressor as in a conventional case, can be reliably achieved.

The pressure switch 24 of the compressor 50 is connected to the neutral point 29A of the stator 22 of the motor element 20. Accordingly, with the compressor 50, when there is an abnormal pressure rise inside the sealed container 3, all the three phases of the stator 22 are disconnected by the operation of the pressure switch 24, and operation is thereby stopped. Therefore, with the compressor 50, an abnormal pressure rise can be handled by the compressor alone, without depending on the drive control device 57. Accordingly, with the compressor 50, safety may be taken more into account.

An operating pressure (the first set pressure) of the pressure switch 24 is set to a predetermined pressure that is lower than a burst pressure relative to an inner pressure rise in the sealed container 3 and higher than a design pressure of the compressor 50. Accordingly, with the compressor 50, an inconvenience due to stopping of the compressor 50 in a normal operation range, and damages to the sealed container 3 and the compression element 4 due to stopping of the compressor 50 due to an abnormal pressure rise can be prevented.

Furthermore, the pressure switch 24 recovers when the pressure inside the sealed container 3 falls below an operating pressure (the second set pressure) of the pressure switch 24. When the pressure switch 24 is recovered, operation of the compressor 50 is enabled. Accordingly, with the compressor 50, even in case of inconveniences occurring at the time of installation or transfer of a refrigeration cycle device (a refrigeration cycle device 100 described with reference to FIG. 7) or at the time of replacement of the compressor 50, for example, the refrigeration cycle device can be normally operated.

Furthermore, by enabling the pressure switch 24 to be recovered, the operation of the pressure switch 24 can be checked at the time of manufacture of the compressor 50 or the refrigeration cycle device. Accordingly, with the compressor 50, reliability can be ensured with respect to protection from pressure by checking the operation of the pressure switch 24.

Furthermore, for example, in a case where the pressure is abnormally increased because of a valve on a high-pressure pipe side and a valve on a low-pressure pipe side being forgotten to be opened, the pressure switch 24 stops the compressor 50 so as not to be recovered. Accordingly, in a case where the pressure switch 24 does not recover, it is considered that some kind of inconvenience is caused, for example, at the time of installation or transfer of the refrigeration cycle device or at the time of replacement of the compressor 50. For example, in the example described above, the compressor 50 can be operated after checking opening and closing of the valve on the high-pressure pipe side and the valve on the low-pressure pipe side and opening again the valve on the high-pressure pipe side and the valve on the low-pressure pipe side, which are closed.

Furthermore, the pressure inside the sealed container 3 may be abnormally increased by volume expansion due to evaporation of liquid refrigerant stored in the sealed container 3 or by sudden compression of liquid refrigerant in the compression element 4. With the compressor 50, also in such a case, since the pressure switch 24 is unrecoverable, reoperation can be prevented in a case where the sealed container 3 or the compression element 4 is damaged by the abnormal pressure rise. Accordingly, an abnormally high temperature due to an increase in sliding heat caused by reoperation of the compression element 4 when the sealed container 3 or the compression element 4 is damaged can be prevented.

Meanwhile, FIG. 2 illustrates an example of the compressor 50 that is provided with the drive control device 57, where the drive control device 57 converts the AC voltage of the commercial AC power supply 56 into a DC, converts the DC into an AC voltage by switching, and applies the AC voltage to the motor element 20, but the electrical circuit configuration is not limited to the one illustrated in FIG. 2. For example, a circuit configuration as illustrated in FIG. 4 where the drive control device 57 is not provided is also possible. That is, the compressor 50 is capable of achieving protection from an abnormal pressure rise by itself, by disconnecting all the windings by the pressure switch 24, and thus, the operation of the compressor 50 does not have to be stopped by the drive control device 57, and protection from a pressure rise can be achieved even when the drive control device 57 is not included.

### <Advantageous Effects of Compressor 50>

As described above, the compressor 50 includes the sealed container 3, the compression element 4 installed inside the sealed container 3 and configured to compress refrigerant, the motor element 20 installed inside the sealed container 3, as a drive source of the compression element 4, and the pressure switch 24 installed inside the sealed container 3 and configured to open the normally closed contacts 25 when the pressure inside the sealed container 3 reaches or exceeds the first set pressure, where the pressure switch 24 is connected to all of connection parts of windings forming a part of the motor element 20.

Accordingly, with the compressor 50, driving of the motor element 20 can be stopped in response to an abnormal pressure rise due to clogging of the discharge pipe of the compressor 50, for example, and reliability of protection of the compressor 50 is increased.

Furthermore, with the compressor 50, the motor element 20 is driven by a three-phase AC, and the pressure switch 24 is connected to the neutral point 29A of the windings that is the connection parts.

Accordingly, with the compressor 50, at the time of operation of the pressure switch 24, electrical connection at the neutral point 29A of the motor element 20 is disconnected and operation of the compressor 50 is stopped, and thus, an abnormal pressure rise can be handled by the compressor alone.

Furthermore, with the compressor 50, the pressure switch 24 closes the normally closed contacts 25 when the pressure inside the sealed container 3 reaches or exceeds the first set pressure, and then, the pressure inside the sealed container 3 falls to or below the second set pressure, which is lower than the first set pressure.

Accordingly, with the compressor 50, since the pressure switch 24 is recoverable, operation of the pressure switch 24 can be checked at the time of manufacture of the compressor 50, for example, and reliability can be increased with respect to protection from pressure.

Furthermore, with the compressor 50, the second set pressure is set to a pressure that is lower than the operating pressure of the pressure switch 24, and thus, a pressure switch having a complicated configuration is not necessarily be provided, and the compressor 50 can be easily manufactured at a low cost.

Moreover, with the compressor 50, when the pressure inside the sealed container 3 reaches the third set pressure, which is higher than the first set pressure, the pressure switch 24 keeps the normally closed contacts 25 open, and thus, reoperation can be prevented in a case where the sealed container 3 or the compression element 4 is damaged by an abnormal pressure rise.

Meanwhile, the first set pressure P1, the second set pressure P2, and the third set pressure P3 are determined as appropriate depending on refrigerant that is used, specifications of the compressor 50, and specifications of the refrigeration cycle device where the compressor 50 is installed. Furthermore, by enabling rewriting of the first set pressure P1, the second set pressure P2, and the third set pressure P3, set pressures can be changed according to an installation location of the compressor 50, for example, and safety can be further increased.

Furthermore, in Embodiment 1, the pressure switch 24 is set to operate at a predetermined pressure, but the pressure switch 24 may be set to operate at a pressure that is ⅓ or less of a burst pressure relative to an inner pressure rise in the sealed container 3 or a structural component of the refrigeration cycle device and that is equal to or higher than the design pressure of the compressor 50. This can prevent fatigue failure of the sealed container 3 or a structural component of the refrigeration cycle device even when the pressure is repeatedly increased, and reliability can be further ensured for protection from pressure.

Furthermore, the pressure switch 24 is set to recover at a predetermined pressure. A recovery pressure of the pressure switch 24 may be set to recover at a pressure that is lower than the design pressure of the compressor 50 and that is lower than the operating pressure of the pressure switch 24 by 0.5 MPa or more. This can prevent frequent repetition of operating and stopping of the compressor 50.

Furthermore, Embodiment 1 describes a compression method of the vane compressor 50 as a representative example, but the compression method of the compressor 50 is not particularly limited. For example, the compressor 50 may be a scroll compressor, a screw compressor, or a reciprocating compressor.

### Embodiment 2

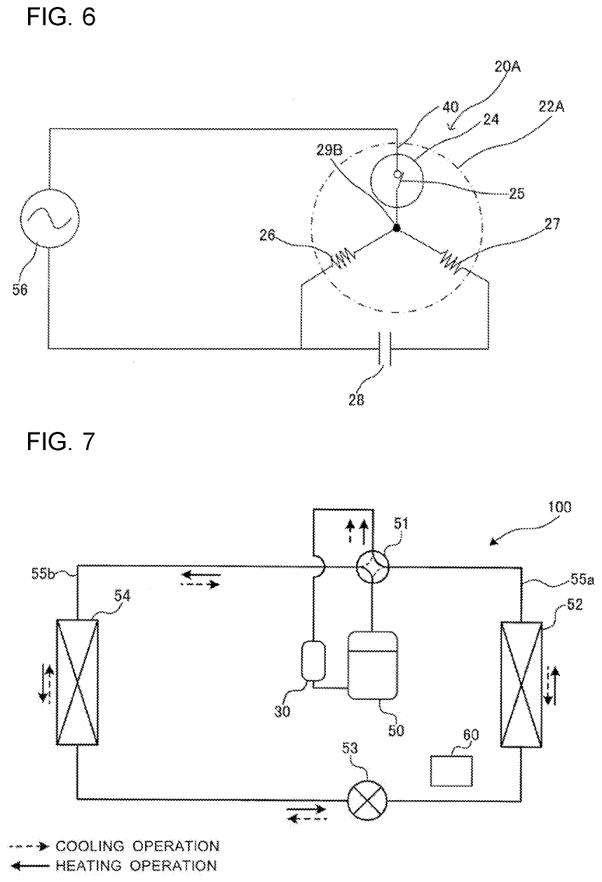

FIG. 5 is a schematic configuration diagram illustrating an example electrical configuration of a compressor 50A according to Embodiment 2 of the present invention. FIG. 6 is a schematic configuration diagram illustrating another example of electrical configuration of the compressor 50A. A configuration of the compressor 50A will be described with reference to FIGS. 5 and 6. A basic mechanical configuration of the compressor 50A according to Embodiment 2 is the same as that of the compressor 50 described in Embodiment 1. Differences from Embodiment 1 will be mainly described in Embodiment 2, and the same parts as those in Embodiment 1 will be denoted by the same reference sign and a description thereof will be omitted.

Embodiment 1 describes an example where the motor element 20 is driven by a three-phase AC, but Embodiment 2 describes an example where a motor element 20A is driven by a single-phase AC.

### <Motor Element 20A>

As in the case of the motor element 20 described in Embodiment 1, the motor element 20A has the function of driving the compression element 4.

The motor element 20A includes the rotor 21, a stator 22A, and the like. The stator 22A is fixed while being in contact with the inner peripheral surface of the sealed container 3.

The stator 22A at least includes a stator core formed of a plurality of electromagnetic steel sheets that are laminated one on another, and windings that are concentratedly wound around teeth of the stator core across insulating element. The lead wire 23 is connected to the windings of the stator 22A. The lead wire 23 is connected to the glass terminal 2b that is provided at the upper container 2 to supply power from outside the sealed container 3.

As illustrated in FIG. 5, the motor element 20A is a single-phase induction motor including a main winding 26 and an auxiliary winding 27 at the stator 22A. An operating capacitor 28 configured to activate the motor element 20A is connected in series with the auxiliary winding 27. The main winding 26 and the auxiliary winding 27 are commonly connected to a common point 29B that is connection parts of the windings. The pressure switch 24 including two or more normally closed contacts 25 is connected to the common point 29B. As described in Embodiment 1, the pressure switch 24 closes the normally closed contacts 25 when the pressure inside the sealed container 3 reaches or exceeds a predetermined operating pressure.

Next, operation of the compressor 50A will be described.

The motor element 20A is an induction motor that is driven by a single-phase AC power that is supplied. Accordingly, a starting torque is not obtained simply by inputting a single-phase AC to the motor element 20A. Therefore, the motor element 20A is configured to be started by application of a rotational torque from a source other than an input power source. Specifically, by connecting the operating capacitor 28 in series with the auxiliary winding 27, a phase lead of a current that flows through the auxiliary winding 27 can be made approximately 90 degrees relative to a current that flows through the main winding 26. The motor element 20A thereby obtains the starting torque and starts operating.

When the compressor 50A is operated, and the pressure inside the sealed container 3 reaches or exceeds a predetermined operating pressure that is set in advance (the first set pressure P1 illustrated in FIG. 3), the pressure switch 24 operates, and opens the normally closed contacts 25. When the normally closed contacts 25 are opened, all the windings are disconnected, and a current does not flow to the stator 22. When a current does not flow to the stator 22, the operation of the compressor 50 is stopped, and a pressure rise in the sealed container 3 is prevented.

On the other hand, when the pressure inside the sealed container 3 falls to or below a predetermined recovery pressure that is set in advance (the second set pressure P2 illustrated in FIG. 3), the pressure switch 24 is recovered, and the normally closed contacts 25 are closed. When the normally closed contacts 25 are closed, a current flows between the windings. When a current flows to the stator 22, the motor element 20A starts to operate again, and operation of the compressor 50A is started again.

When the compressor 50A is operated, and the pressure inside the sealed container 3 exceeds a predetermined pressure that is set in advance (the third set pressure P3 illustrated in FIG. 3), the pressure switch 24 operates, and causes the normally closed contacts 25 to be normally open. In this case, the pressure switch 24 keeps the normally closed contacts 25 open, maintains a state where all the windings are disconnected, and is not able to be recovered.

As described above, the compressor 50A includes the pressure switch 24 inside the sealed container 3, the pressure switch 24 configured to operate and stop the compressor 50A when the pressure inside the sealed container 3 reaches the predetermined operating pressure. Accordingly, with the compressor 50A, protection from an abnormal pressure rise due to clogging of the discharge pipe or the like, which is not achieved when the pressure switch is provided outside the compressor as in an existing case, can be reliably achieved.

Furthermore, the pressure switch 24 of the compressor 50A is connected to the common point 29B of the stator 22A of the motor element 20A. Accordingly, with the compressor 50A, when there is an abnormal pressure rise inside the sealed container 3, all the windings of the stator 22A are disconnected by the operation of the pressure switch 24, and operation is thereby stopped. Therefore, with the compressor 50A, an abnormal pressure rise can be handled by the compressor alone, without depending on the drive control device 57. Accordingly, with the compressor 50A, safety may be taken more into account.

Furthermore, the pressure switch 24 recovers when the pressure inside the sealed container 3 falls to or below an operating pressure of the compressor 50A. When the pressure switch 24 is recovered, operation of the compressor 50A is enabled. Accordingly, with the compressor 50A, even in case of inconveniences occurring at the time of installation or transfer of the refrigeration cycle device (the refrigeration cycle device 100 described with reference to FIG. 7) or at the time of replacement of the compressor 50A, for example, the refrigeration cycle device can be normally operated.

Furthermore, by enabling the pressure switch 24 to be recovered, the operation of the pressure switch 24 can be checked at the time of manufacture of the compressor 50A or the refrigeration cycle device. Accordingly, with the compressor 50A, reliability can be ensured with respect to protection from pressure by checking the operation of the pressure switch 24.

Furthermore, for example, in a case where the pressure is abnormally increased because of a valve on a high-pressure pipe side and a valve on a low-pressure pipe side being forgotten to be opened, the pressure switch 24 stops the compressor 50A in a manner not able to be recovered. Accordingly, in a case where the pressure switch 24 does not recover, it is considered that some type of inconvenience occurs, for example, at the time of installation or transfer of the refrigeration cycle device or at the time of replacement of the compressor 50A. For example, in the example described above, the compressor 50 can be operated after checking opening and closing of the valve on the high-pressure pipe side and the valve on the low-pressure pipe side and opening again the valve on the high-pressure pipe side and the valve on the low-pressure pipe side, which are closed.

Furthermore, the pressure inside the sealed container 3 may be abnormally increased by volume expansion due to evaporation of liquid refrigerant stored in the sealed container 3 or by sudden compression of liquid refrigerant in the compression element 4. With the compressor 50A, also in such a case, since the pressure switch 24 is unrecoverable, reoperation can be prevented in a case where the sealed container 3 or the compression element 4 is damaged by the abnormal pressure rise. Accordingly, an abnormally high temperature due to an increase in sliding heat caused by reoperation of the compression element 4 when the sealed container 3 or the compression element 4 is damaged can be prevented.

### <Advantageous Effects of Compressor 50A>

As described above, with the compressor 50A, the motor element 20A is driven by a single-phase AC, the windings include the main winding 26 and the auxiliary winding 27, and the pressure switch is connected to the common point 29B of the main winding 26 and the auxiliary winding 27, that is the connection parts, or a common line 40.

Accordingly, the compressor 50A achieves the same advantageous effects as those in Embodiment 1, and also, at the time of operation of the pressure switch 24, operation of the compressor 50A is stopped by disconnecting electrical connection of the common point 29B of the motor element 20A or the common line 40, and thus, an abnormal pressure rise can be handled by the compressor alone.

Meanwhile, FIG. 5 illustrates an example where the pressure switch 24 is connected to the common point 29B, but a connection position of the pressure switch 24 is not limited to the one illustrated in FIG. 5. For example, the pressure switch 24 may be connected to the common line 40, as illustrated in FIG. 6.

Furthermore, Embodiment 2 describes a compression method of the vane compressor 50A as a representative example, as in the case of the compressor 50, but the compression method of the compressor 50A is not particularly limited. For example, the compressor 50A may be a scroll compressor, a screw compressor, or a reciprocating compressor.

### Embodiment 3

FIG. 7 is a refrigerant circuit diagram schematically illustrating a refrigerant circuit configuration of a refrigeration cycle device 100 according to Embodiment 3 of the present invention. Configuration and operation of the refrigeration cycle device 100 will be described with reference to FIG. 7. The refrigeration cycle device 100 according to Embodiment 3 includes, as one element of a refrigerant circuit, one of the compressor 50 according to Embodiment 1 or the compressor 50A according to Embodiment 2. For the sake of convenience, FIG. 7 illustrates a case where the compressor 50 according to Embodiment 1 is included.

### <Configuration of Refrigeration Cycle Device 100>

The refrigeration cycle device 100 includes the compressor 50, a flow switching device 51, a first heat exchanger 52, an expansion device 53, and a second heat exchanger 54. The compressor 50, the first heat exchanger 52, the expansion device 53, and the second heat exchanger 54 form a refrigerant circuit by being connected by a high-pressure side pipe 55a and a low-pressure side pipe 55b. The accumulator 30 is installed on an upstream side of the compressor 50.

As explained in Embodiment 1, the compressor 50 compresses refrigerant that is suctioned, and places the refrigerant in a high-temperature, high-pressure state. The refrigerant compressed by the compressor 50 is discharged from the compressor 50, and is delivered to the first heat exchanger 52 or the second heat exchanger 54.

The flow switching device 51 switches flow of refrigerant between heating operation and cooling operation. That is, at the time of heating operation, the flow switching device 51 is switched to connect the compressor 50 and the second heat exchanger 54, and at the time of cooling operation, the flow switching device 51 is switched to connect the compressor 50 and the first heat exchanger 52. Meanwhile, the flow switching device 51 may be configured by a four-way valve, for example. Alternatively, a two-way valve or a three-way valve may be adopted as the flow switching device 51.

The first heat exchanger 52 functions as an evaporator at the time of heating operation, and functions as a condenser at the time of cooling operation. That is, in the case where the first heat exchanger 52 functions as an evaporator, heat is exchanged between low-temperature, low-pressure refrigerant flowing out of the expansion device 53 and air that is supplied by a fan, not illustrated, for example, and low-temperature, low-pressure liquid refrigerant (or two-phase gas-liquid refrigerant) is evaporated. In the case where the first heat exchanger 52 functions as a condenser, heat is exchanged between high-temperature, high-pressure refrigerant that is discharged from the compressor 50 and air that is supplied by the fan, not illustrated, for example, and high-temperature, high-pressure gas refrigerant is condensed. Meanwhile, the first heat exchanger 52 may be a refrigerant-water heat exchanger. In this case, the first heat exchanger 52 exchanges heat between refrigerant and a heating medium such as water.

The expansion device 53 expands and depressurizes the refrigerant flowing out of the first heat exchanger 52 or the second heat exchanger 54. The expansion device 53 may be a motor-driven expansion valve capable of adjusting a flow rate of refrigerant, for example. Meanwhile, as the expansion device 53, a mechanical expansion valve adopting a diaphragm as a pressure receiving unit, a capillary tube, or the like can be adopted, instead of the motor-driven expansion valve.

The second heat exchanger 54 functions as a condenser at the time of heating operation, and functions as an evaporator at the time of cooling operation. That is, in the case where the second heat exchanger 54 functions as a condenser, heat is exchanged between high-temperature, high-pressure refrigerant that is discharged from the compressor 50 and air that is supplied by a fan, not illustrated, for example, and high-temperature, high-pressure gas refrigerant is condensed. In the case where the second heat exchanger 54 functions as an evaporator, heat is exchanged between low-temperature, low-pressure refrigerant flowing out of the expansion device 53 and air that is supplied by the fan, not illustrated, for example, and low-temperature, low-pressure liquid refrigerant (or two-phase gas-liquid refrigerant) is evaporated. Meanwhile, the second heat exchanger 54 may be a refrigerant-water heat exchanger. In this case, the second heat exchanger 54 exchanges heat between refrigerant and a heating medium such as water.

The refrigeration cycle device 100 further includes a controller 60 configured to integrally control the entire refrigeration cycle device 100. Specifically, the controller 60 controls a driving frequency of the compressor 50 according to required cooling capacity or heating capacity. That is, the controller 60 includes the drive control device 57 described in Embodiment 1. Furthermore, the controller 60 controls an opening degree of the expansion device 53 according to an operation state and each mode. Moreover, the controller 60 controls the flow switching device 51 according to each mode.

That is, the controller 60 controls each actuator (such as the compressor 50, the expansion device 53, or the flow switching device 51) by using information transmitted from each temperature sensor, not illustrated, or each pressure sensor, not illustrated, based on an operation instruction issued from a user.

Meanwhile, the controller 60 may be hardware such as a circuit device configured to implement the function of the controller 60, or may be an arithmetic device, such as a microcomputer or a CPU, and software executed by the arithmetic device.

### <Operation of Refrigeration Cycle Device 100>

Next, operation of the refrigeration cycle device 100 will be described together with flow of refrigerant. Here, operation of the refrigeration cycle device 100 at the time of cooling operation will be described, using a case where a heat exchange fluid of the first heat exchanger 52 and the second heat exchanger 54 is air as an example. In FIG. 7, a flow of refrigerant at the time of cooling operation is indicated by dotted line arrows, and a flow of refrigerant at the time of heating operation is indicated by solid line arrows.

By driving the compressor 50, refrigerant in a state of high-temperature, high-pressure gas is discharged from the compressor 50. The high-temperature, high-pressure gas refrigerant (single phase) that is discharged from the compressor 50 flows into the first heat exchanger 52. At the first heat exchanger 52, heat is exchanged between the high-temperature, high-pressure gas refrigerant flowing in and air that is supplied by the fan, not illustrated, and the high-temperature, high-pressure gas refrigerant is condensed into high-pressure liquid refrigerant (single phase).

The high-pressure liquid refrigerant that is delivered from the first heat exchanger 52 is caused to be refrigerant in two phases of low-pressure gas refrigerant and liquid refrigerant by the expansion device 53. The refrigerant in two phases flows into the second heat exchanger 54. At the second heat exchanger 54, heat is exchanged between the refrigerant in two phases flowing in and air that is supplied by the fan, not illustrated, and the liquid refrigerant in the refrigerant in two phases is evaporated to leave the low-pressure gas refrigerant (single phase). The low-pressure gas refrigerant that is delivered from the second heat exchanger 54 flows into the compressor 50 through the accumulator 30 and is compressed into high-temperature, high-pressure gas refrigerant, and is discharged again from the compressor 50. This cycle is repeated.

The refrigeration cycle device 100 is operated at the time of heating operation by changing the flow of refrigerant to the flow indicated by the solid line arrows in FIG. 7 by the flow switching device 51.

With the refrigeration cycle device 100, for example, installation, transfer, or replacement of the compressor 50 is performed in a state where a high-pressure side pipe valve and a low-pressure side pipe valve, which are not illustrated, are closed and the refrigerant circuit is placed in a state that does not allow circulation of refrigerant. The high-pressure side pipe valve and the low-pressure side pipe valve, which are not illustrated, are often installed between units housing respective structural elements, and a worker is to access each unit after closing the high-pressure side pipe valve and the low-pressure side pipe valve.

Then, after a task is done, the worker opens the high-pressure side pipe valve and the low-pressure side pipe valve, and places the refrigerant circuit in a state that allows circulation of refrigerant. At this time, if at least one of the high-pressure side pipe valve or the low-pressure side pipe valve is forgotten to be opened, the pressure in the compressor 50 is abnormally increased. However, the refrigeration cycle device 100 is provided with the compressor 50 according to Embodiment 1, and even if abnormal increase in the high pressure occurs due to some type of abnormality, the compressor 50 can be prevented by the pressure switch 24 from being driven. Accordingly, the refrigeration cycle device 100 achieves high reliability.

### <Advantageous Effects of Refrigeration Cycle Device 100>

As described above, the refrigeration cycle device 100 includes a refrigerant circuit where the compressor 50, the flow switching device 51, the first heat exchanger 52, the expansion device 53, and the second heat exchanger 54 are connected by the high-pressure side pipe 55a and the low-pressure side pipe 55b.

Accordingly, with the refrigeration cycle device 100, even if abnormal increase in the high pressure occurs due to any one of the high-pressure side pipe valve or the low-pressure side pipe valve being forgotten to be opened, for example, the compressor 50 can be stopped by the pressure switch 24, and reliability is increased.

Meanwhile, refrigerant may be caused to flow along a specific direction, without providing the flow switching device 51, which is provided on a discharge side of the compressor 50.

Furthermore, refrigerant used for the refrigeration cycle device 100 is not particularly limited, and refrigerant such as carbon dioxide, R410A, R32, or HFO1234yf may be used.

Moreover, application examples of the refrigeration cycle device 100 include an air-conditioning apparatus, a water heater, a freezer, or a combined air-conditioning and hot water supply combined device, and reliability is increased in any of the cases.

### REFERENCE SIGNS LIST

1 lower container 2 upper container 2a discharge pipe 2b glass terminal 3 sealed container 4 compression element 5 cylinder 5a cylinder chamber 6 upper bearing 6a discharge hole 6b discharge valve
7 lower bearing 8 drive shaft 8a eccentric shaft portion 8b main shaft portion 8c sub shaft portion 9 rolling piston 10 discharge muffler 10a discharge hole 11 suction pipe 20 motor element
20A motor element 21 rotor 22 stator 22A stator 23 lead wire
24 pressure switch 25 normally closed contact 26 main winding 27 auxiliary winding 28 operating capacitor 29A neutral point 29B common point
30 accumulator 40 common line 50 compressor 50A compressor 51 flow switching device 52 first heat exchanger 53 expansion device 54 second heat exchanger 55a high-pressure side pipe 55b low-pressure side pipe 56 commercial AC power supply 57 drive control device 60 controller
100 refrigeration cycle device Lu winding Lv winding Lw winding

1. A compressor comprising:
a sealed container;
a compression element installed inside the sealed container and configured to compress refrigerant;
a motor element installed inside the sealed container and serves as a drive source of the compression element; and
a pressure switch installed inside the sealed container and configured to open a normally closed contact when pressure inside the sealed container reaches or exceeds a first set pressure, wherein
the pressure switch is connected to all of connection parts of windings forming a part of the motor element.

2. The compressor of claim 1, wherein
the motor element is driven by a three-phase AC, and
the pressure switch is connected to a neutral point of the windings that is the connection parts.

3. The compressor of claim 1, wherein
the motor element is driven by a single-phase AC,
the windings include a main winding and an auxiliary winding, and
the pressure switch is connected to a common point of the main winding and the auxiliary winding that is the connection parts, or to a common line.

4. The compressor of claim 1, wherein the pressure switch which is configured to close the normally closed contact when the pressure inside the sealed container reaches or exceeds the first set pressure and then the pressure inside the sealed container falls to or below a second set pressure that is lower than the first set pressure.

5. The compressor of claim 1, wherein the pressure switch is configured to keep the normally closed contact open when the pressure inside the sealed container reaches a third set pressure that is equal to or higher than the first set pressure.

6. A refrigeration cycle device comprising a refrigerant circuit where the compressor of claim 1, a condenser, an expansion device, and an evaporator are connected by a high-pressure side pipe and a low-pressure side pipe.
